(19) United States
(12) Patent Application Publication
(10) Pub. No.: US 2009/0276333 A1
(43) Pub. Date: Nov. 5, 2009

(54) Electronic submission and management of digital products for network-based distribution

(76) Inventors: Ricardo D. Cortes, Los Gatos, CA (US); Max Muller, San Jose, CA (US); Michael Howard Walker, Seattle, WA (US); David Alonzo Van Tassell, Campbell, CA (US); Aloke Bhatnagar, Campbell, CA (US); Ashish Agarwal, San Jose, CA (US); Lynne Allison Sandberg, San Francisco, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/286,076

(22) Filed: Sep. 26, 2008

Related U.S. Application Data
(60) Provisional application No. 61/050,478, filed on May 5, 2008.

(51) Int. Cl. G06Q 30/00; G06F 17/28; G06F 3/048; G06Q 50/00

(52) U.S. Cl. 705/27; 707/9; 705/400; 704/8; 715/708

(57) ABSTRACT

An improved system and method for submitting, distributing and/or managing digital products with respect to a product distribution site are disclosed. The submission of digital products to the product distribution site is able to be performed by numerous submitters in a uniform and computer-assisted manner. The submitted digital products can then be managed in a largely automated manner and made available for online purchase and distribution at the product distribution site. Once a digital product is submitted, the user can access the status of the digital product submission to obtain information of whether the digital product has been approved or rejected. In one embodiment, the digital products are computer program products (e.g., computer software programs).

### CROSS-REFERENCE TO RELATED APPLICATION

This application claims priority to U.S. Provisional Patent Application No. 61/050,478, filed May 5, 2008, entitled “ELECTRONIC SUBMISSION AND MANAGEMENT OF DIGITAL PRODUCTS FOR NETWORK-BASED DISTRIBUTION”, which is hereby incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

1. Field of the Invention

The present invention relates to submission of digital products and, more particularly, to electronic submission of digital products for purposes of network-based distribution.

2. Description of the Related Art

Today, online media stores, such as iTunes™ T Media Store, allow customers (i.e., online users) to purchase or rent media items, such as music or videos, over the Internet. Often, at online media stores, numerous media items made available and are provided by various different content providers, such as music labels or movie companies. Software tools, such as iProducer™ and Label Connect™ available from Apple Inc. of Cupertino, Calif., can assist content providers with online submission of media content to the iTunes™ Media Store.

Software programs are also available to purchased or licensed at retail stores as well as online stores. Conventionally, a software program is primarily purchased as a compact disc (CD) containing the software program. Alternatively, purchasers can often purchase and download a software program from an online retailer or a software provider's website. However, when an online retailer operates to sell software programs of various independent parties, there are difficulties in providing the digital program files and supporting information/files to the online retailers. This problem is exacerbated by a large number of small software providers that often desire to partner with the online retailer. As a result, online retailers that receive online submissions face substantial burdens and difficulties due to the wide range of variation with respect to the submissions.

Therefore, there is a need for improved approaches to facilitate submission of software programs to online retailers.

### SUMMARY OF THE INVENTION

The invention relates to an improved system and method for submitting, distributing and/or managing digital products with respect to a product distribution site. The submission of digital products to the product distribution site is able to be performed by numerous submitters in a uniform and computer-assisted manner. The submitted digital products can then be managed in a largely automated manner and made available for online purchase and distribution at the product distribution site. Once a digital product is submitted, the user can access the status of the digital product submission to obtain information of whether the digital product has been approved or rejected. In one embodiment, the digital products are computer program products (e.g., computer software programs).

In one embodiment, the invention pertains to a method and system for controlled submission of digital products in a client-server environment. The controlled submission can assist user in properly submitting digital products and can use user accounts to restrict unauthorized access. For quality control, manual review of submissions can still be performed prior to distribution of the digital products from an online product distribution site.

The invention can be implemented in numerous ways, including as a method, system, device, apparatus (including computer readable medium and graphical user interface). Several embodiments of the invention are discussed below.

As a method for submitting a digital product to an online repository for distribution, one embodiment of the invention can, for example, include at least: receiving product information pertaining to a digital product to be submitted to the online repository; uploading at least one electronic file pertaining to the digital product; receiving at least one distribution parameter to be used for the digital product; and submitting the digital product to the online repository for distribution.

As a system for facilitating submission and management of digital products to be distributed online, one embodiment of the invention can, for example, include at least: a product management and distribution system configured to permit content providers to submit digital products and manage distribution of their digital products. The product management and distribution system can include at least a product submission module configured to receive submission of new digital products for distribution, each of the new digital products being submitted including at least providing product information and product distribution information. The product information can include at least a product name and a supported device type indication, and wherein the product distribution information includes at least one pricing parameter for use in online distribution of the corresponding digital product.

As a graphical user interface for use in submitting a digital product to an online distribution site, one embodiment of the invention can, for example, includes at least: a digital product information window for assisting a user in providing product information, the product information including information that is associated with a digital product; a digital product upload window for assisting the user in selecting and uploading one or more electronic files that pertain to the digital product; and a distribution parameters window for assisting the user in specifying one or more distribution parameters that are used to control one or more aspects of distribution of the digital product by the online distribution site.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The invention will be readily understood by the following detailed description in conjunction with the accompanying drawings, wherein like reference numerals designate like elements, and in which:

FIG. 1 is a block diagram of a product submission and distribution system according to one embodiment of the invention.

FIG. 2 is a flow diagram of a digital product submission process according to one embodiment of the invention.

FIG. 3 is a block diagram of a product submission and management system according to one embodiment of the invention.

FIG. 4 is a flow diagram of a product submission and management process according to one embodiment of the invention.

FIG. 5 is a block diagram of a project management system according to one embodiment of the invention.

FIGS. 6A and 6B are flow diagrams of a product management process according to one embodiment of the invention.

FIGS. 7A-7D are representative screen shots pertaining to basic user interaction with an online product distribution site according to one embodiment of the invention.

FIGS. 8A-8E are representative screen shots pertaining to uploading of one or more files according to one embodiment of the invention.

FIGS. 9A-9D are representative screen shots pertaining to setting pricing parameters according to one embodiment of the invention.

FIGS. 10A-10D are representative screen shots pertaining to setting localization parameters according to one embodiment of the invention.

FIG. 11 is a screen shot of a representative product submission page according to one embodiment of the invention.

FIGS. 12A and 12B are screen shots of a representative product management base page according to one embodiment of the invention.

### DETAILED DESCRIPTION OF THE INVENTION

The invention relates to an improved system and method for submitting, distributing and/or managing digital products with respect to a product distribution site. The submission of digital products to the product distribution site is able to be performed by numerous submitters in a uniform and computer-assisted manner. The submitted digital products can then be managed in a largely automated manner and made available for online purchase and distribution at the product distribution site. Once a digital product is submitted, the user can access the status of the digital product submission to obtain information of whether the digital product has been approved or rejected. In one embodiment, the digital products are computer program products (e.g., computer software programs).

In one embodiment, the invention pertains to a method and system for controlled submission of digital products in a client-server environment. The controlled submission can assist user in properly submitting digital products and can use user accounts to restrict unauthorized access. For quality control, manual review of submissions can still be performed prior to distribution of the digital products from an online product distribution site.

Files can be authorized before submission is permitted. Following submission, the digital product submitted can be evaluated for quality control. Although at least a portion of the quality control can be automated, manual review of submissions can still be performed prior to distribution of the digital products from the product distribution site. Additionally, once submitted a submitter can access the status of the submission online and can also resubmit some or all of the components of a prior submission in the event that the earlier submission is deemed deficient. The product distribution site can also be referred to as an online product hosting site.

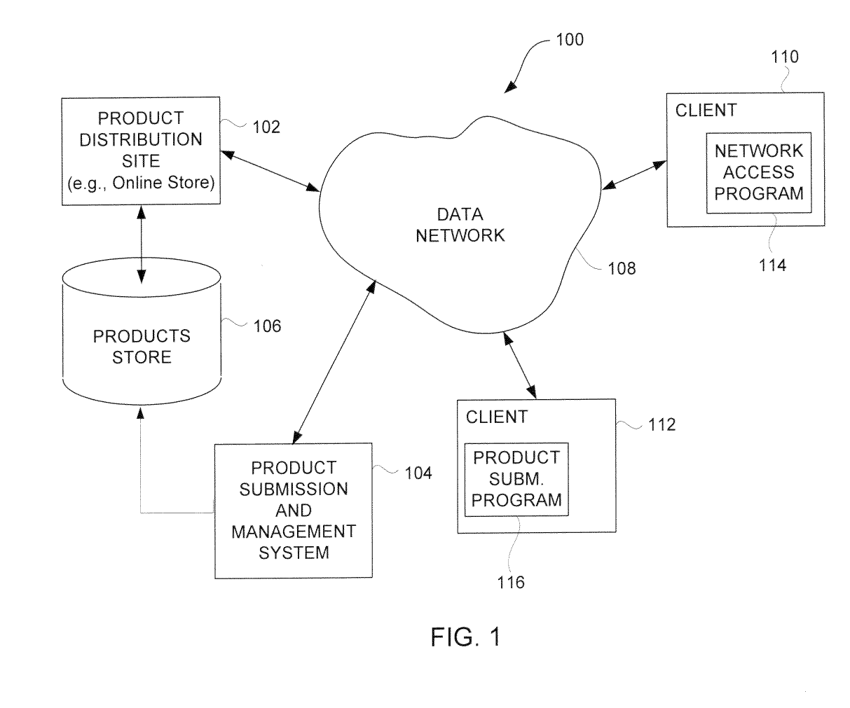

Embodiments of various aspects of the invention are discussed below with reference to FIGS. 1-12B. However, those skilled in the art will readily appreciate that the detailed description given herein with respect to these figures is for explanatory purposes as the invention extends beyond these limited embodiments.

FIG. 1 is a block diagram of a product submission and distribution system 100 according to one embodiment of the invention. The product submission and distribution system 100 includes a product distribution site 102. The product distribution site 102 provides an online access point for distribution of various digital products. For example, the product distribution site 102 can be referred to as an online store. A product submission and management system 104 operates to receive submissions of digital products from various digital product submitters. The product submission and management system 104 can process submission of digital products and authorize distribution of approved digital products. The digital products can be stored in a products store 106. In one embodiment, the products store 106 includes a mass data store and one or more databases. The products store 106 provides mass storage of the numerous digital products that are available for distribution (e.g., purchase or rental). For example, digital products that have been purchased can be accessed from the products store 106 over a data network 108 by way of the product distribution site 102. Examples of digital products are computer program products such as applications (or application programs), animations, or presentations.

The product submission and distribution system 100 also includes a first client 110 and a second client 112. Typically, the product submission and distribution system 100 would include a plurality of different clients 110, 112. The first client 110 includes a network access program 114. The second client 112 includes a product submission program 116. Some clients can also include both the network access program 114 and the product submission program 116. The network access program 114 is an application program (e.g., software application) that operates on the first client 110, which is a computing device. One example of a suitable network access program is a network browser (e.g., Microsoft Explorer or Safari). Another example of a suitable network access program is iTunes™ offered by Apple Inc. The first client 110 is coupled to the product distribution site 102 through the data network 108. Hence, any of the first clients 110 can interact with the product distribution site 102 to review, purchase and/or manage digital products.

The product submission program 116 is also an application program (e.g., software application) that operates on the second client 112, which is a computing device. The product submission program 116 is used to submit digital products to the product submission and management system 104 for eventual distribution by the media distribution site 102. Although the network access program 114 and the product submission program 116 are shown in FIG. 1 as separate programs, it should be understood that such programs can be integrated into a single program or reside on the same client machine.

In the product submission and distribution system 100 shown in FIG. 1, the digital products are submitted to the product submission and management system 104 by way of the product submission program 116. The digital products that have been submitted (e.g., via the second client 112 are processed and then stored in the products store 106. Thereafter, the stored digital products are available to be purchased from the product distribution site 102. Upon purchasing a particular digital product, the product distribution site 102 permits the digital data for the particular digital product to be retrieved from the products store 106 and then delivered (e.g., downloaded) from the product distribution site 102 to the requesting client 110 through the data network 108. In this regard, the product distribution site 102 or some other delivery server (not shown) obtains the digital data corresponding to the particular digital product from the products store 106 and downloads such digital data through the data network 108 to the client 110. The downloaded digital data can then be stored on the client 110. In one embodiment, the downloaded digital data is encrypted as received at the client 110 but is decrypted and then perhaps re-encrypted before persistently stored on the client 110. Thereafter, the client 110 can utilize (e.g., execute) the digital data of the digital product at the client 110.

The product submission and distribution system 100 allows a user of the client 110 to utilize the network access program 114 to browse, search or sort through a plurality of digital products that can be purchased from the product distribution site 102. The network access program 114 may also allow the user to preview or demo some or all of a digital product. In the event that the user of the network access program 114 desires to purchase a particular digital product, the user (via the network access program 114) and the product distribution site 102 can engage in an online commerce transaction in which the user pays for access rights to the particular digital product. In one embodiment, a credit card associated with the user is credited for a purchase or rental amount of the particular digital product.

The submission and purchase of the digital products can be achieved over the data network 108. In other words, the submission and purchase of the digital products can be achieved online. The purchase of media items online can also be referred to as electronic commerce (e-commerce). In one embodiment, the data network 108 includes at least a portion of the Internet. The clients 110, 112 can vary with application but generally are computing devices that have memory storage. Often, the clients 110, 112 are personal computers or other computing devices that are capable of storing and presenting media to their users. In one embodiment, the connections through the data network 108 between the product distribution site 102 and the clients 110, 112 can be through secure connections, such as Secure Sockets Layer (SSL).

Although the product distribution site 102, the product submission and management system 104 and the products store 106 are shown in FIG. 1 as being separate components, it should be understood that any of these components can be combined into one or more apparatus. For example, the product submission and management system 104 can be incorporated into the product distribution site 102. As another example, the products store 106 can be incorporated into the product distribution site 102 or the product submission and management system 104.

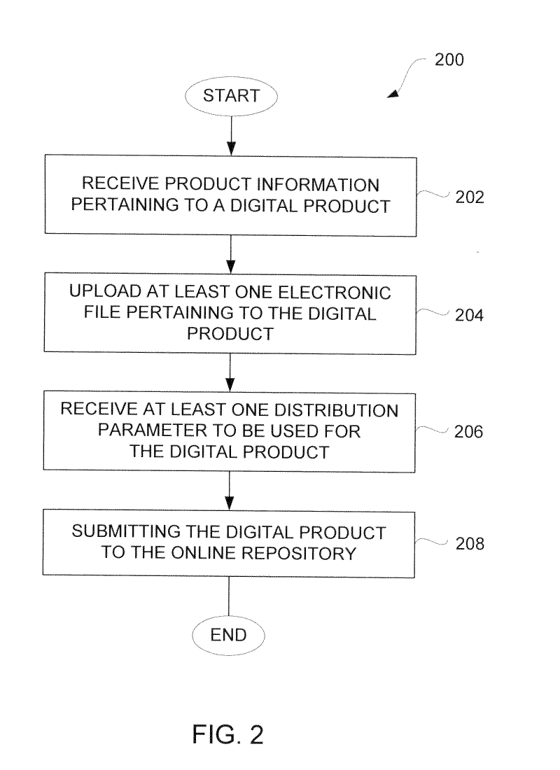

FIG. 2 is a flow diagram of a digital product submission process 200 according to one embodiment of the invention. The digital product submission process 200 can, for example, be performed by a client device, such as the client 114, or a server device, such as the product submission and management system 104.

The digital product submission process 200 can receive 202 product information pertaining to a digital product. The product information can vary depending upon the type of digital product being submitted. In one implementation, one type of digital product that can be submitted to an online repository by the digital product submission process 200 is a digital program product, such as a computer program product. Examples of product information for a computer program product can include one or more of: a product name, a supported device type indication, genre indication, version number, product identifier, support information, and license agreement information.

Next, a least one electronic file pertaining to a digital product can be uploaded 204. The digital product can have one or more electronic files associated therewith. For example, the digital product may include a binary file, a support or help file, and/or one more exemplary screen illustrations.

In addition, a least one distribution parameter to be used with the digital product can be received 206. A distribution parameter is a parameter that can be utilized to control or influence the manner in which the digital product is able to be distributed. One example of a distribution parameter is a pricing parameter. As an example, a pricing parameter can specify a price or a price tier to be associated with the digital product. Other distribution parameters can pertain to digital storefronts from which the digital product is to be distributed from. Still further, distribution parameters could also pertain to preview eligibility, license categories (types), etc.

Thereafter, the digital product can be submitted 208 to the online repository. The online repository can, for example, correspond to the product submission and management system 104. The online repository can receive the one or more electronic files, the associated product information and the one or more distribution parameters. The online repository can then operate to permit distribution of the digital product, as contained in the one or more electronic files, from a product distribution site (e.g., an online store) in accordance with the product information and the one or more distribution parameters. After the submission 208 of the digital product to the online repository, the digital product submission process 200 can end.

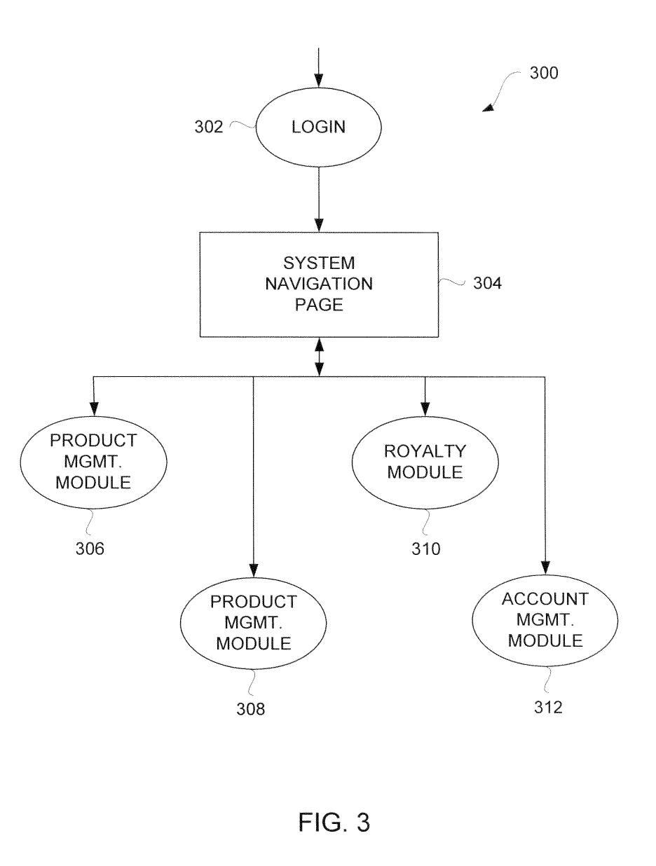

FIG. 3 is a block diagram of a product submission and management system 300 according to one embodiment of the invention. The product submission and management system 300 can, for example, represent one embodiment of the product submission and management system 104 illustrated in FIG. 1.

The product submission and management system 300 can require a login 302. For example, the login can require a user (i.e., digital product submitter) to provide a user name and a password. If the digital product submitter has successfully logged into the product submission and management system 300, the digital product submitter can be presented with a system navigation page 304. From the system navigation page 304, the digital product submitter can access one or more modules that are supported by the product submission and management system 300. According to one embodiment, as illustrated in FIG. 3, the modules supported by the product submission and management system 300 can include a product management module 306, a contract request module 308, a royalty module 310, and an account management module 312.

The product management module 306 can allow the digital product submitter to submit new products and control distribution of such new products. The product management module 306 can also allow the digital product submitter to edit previous submissions. The contract request module 308 can permit the digital product submitter to request a contract with an entity that provides the product distribution. Such a contract can enable the digital products submitter to distribute digital products using a product distribution site (e.g., online store) provided by the entity. The royalty module 310 can assist the digital product submitter in monitoring distribution of all digital products associated with the digital product submitter, including monitoring royalties that will or have in provided to the digital submitter due to distribution of such digital products. For example, the digital product submitter can access monthly royalty reports. The account management module 312 can provide centralized account management for the digital products, including, for example, access permissions, email settings, basic account information to be associated with the digital products matter.

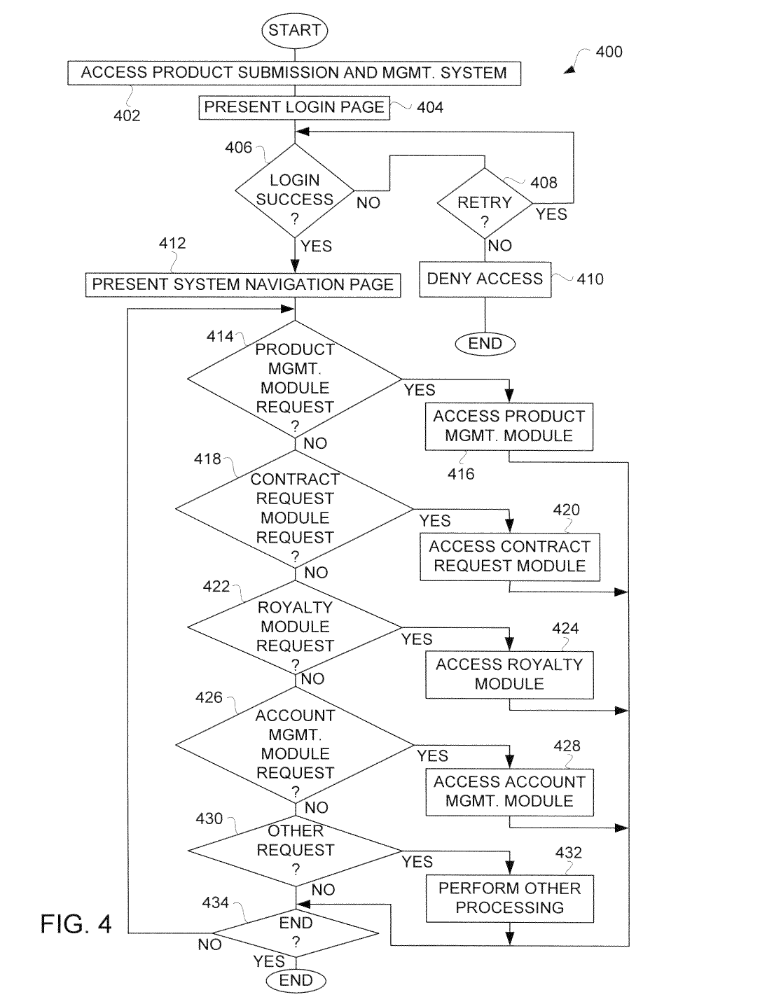

FIG. 4 is a flow diagram of a product submission and management process 400 according to one embodiment of the invention. The product submission and management process 400 can, for example, be performed by a product submission and management system. In this embodiment, it is assumed that the product submission and management system is the product submission and management system 300 illustrated in FIG. 3.

The product submission and management process 400 can begin by accessing 402 the product submission and management system. A login page can then be presented 404 to the user seeking to submit a digital product to the product submission and management system. The user can then enter a user name and password. Thereafter, a decision 406 can determine whether login has been successfully achieved. When the decision 406 determines that login has not been successful, a decision 408 can determine whether a retry for the login is permitted. When the decision 408 determines that a retry is not permitted, access to the product submission and management system is denied 410. Following the block 410, the product submission and management process can end. Alternatively, when the decision 408 determines that a retry is permitted, the product submission and management process 400 can return to repeat the decision 406 so that another login attempt can be permitted.

When the decision 406 determines that login has been successfully achieved, a system navigation page can be presented 412. From the system navigation page, a plurality of different software modules can be accessed. In the embodiment illustrated in FIG. 4, the software modules include a product management module, a contract request module, a royalty module and an account management module. The user can interact with the system navigation page to activate any of these different software modules. More particularly, the processing associated with activating any the different modules is discussed below.

After the system navigation page has been presented 412, a decision 414 can determine whether a product management module request has been received. When the decision 414 determines that a product management module request has been received, a product management module can be accessed 416. On the other hand, when the decision 414 determines that a product management module request has not been received, a decision 418 can determine whether a request for access to the contract request module has been received. When the decision 418 determines that a request to access the contract request module has been received, a contract request module can be accessed 420. Alternatively, when the decision 418 determines that a request to access the contract request module has not been received, a decision 422 can determine whether a royalty module request has been received. When the decision 422 determines that a royalty module request has been received, a royalty module can be accessed 424. On the other hand, when the decision 422 determines that a royalty module request has not been received, a decision 426 can determine whether an account management module request has been received. When the decision 426 determines that an account management module request has been received, an account management module can be accessed 428.

On the other hand, when the decision 426 determines that an account management module request has not been received, a decision 430 can determine whether some other request from the user has been received. When the decision 430 determines that some other request has been received, other processing can be performed 432.

Following each of the blocks 416, 420, 424, 428 and 432 as well as following the decision 430 when some other request has not been received, a decision 434 can determine whether the product submission and management process 400 should end. When the decision 434 determines that the product submission and management process 400 should not end, the processing returns to perform the decision 414 and subsequent blocks so that subsequent user requests can be processed. However, when the decision 434 determines that the product submission and management process 400 should end, the product submission and management process 400 can end.

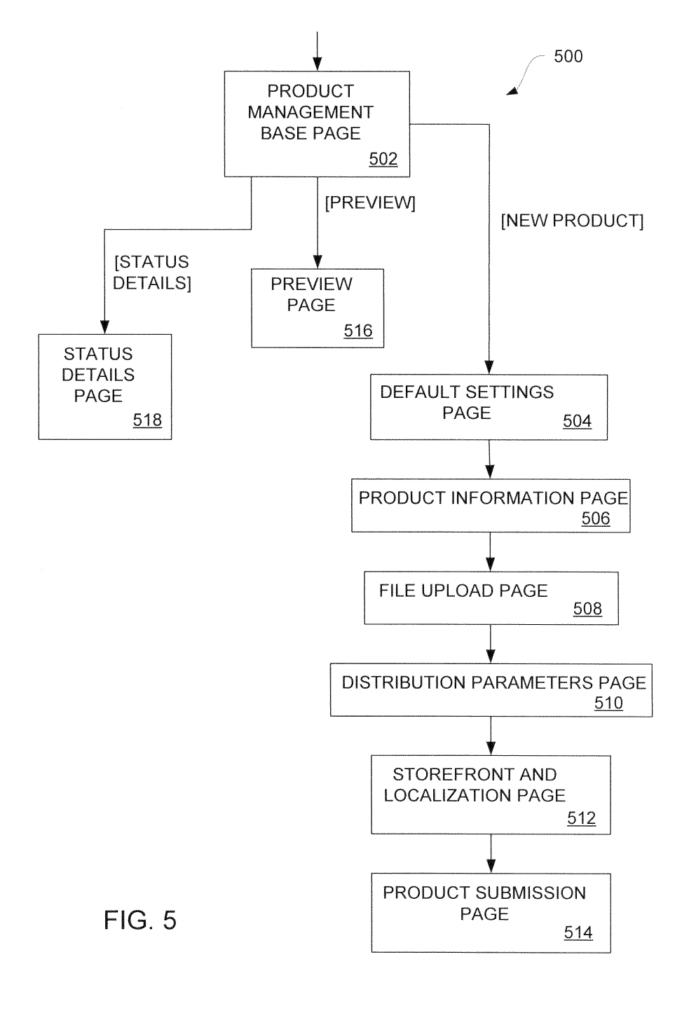

FIG. 5 is a block diagram of a project management system 500 according to one embodiment of the invention. The project management system 500 includes a product management base page 502. From the project management base page 502 a user can navigate to different pages to facilitate (i) addition of a new product to the project management system 500, (ii) preview of product representations for distribution, and/or (iii) review of status details pertaining to one or more products.

When the user interacts with the product management base page 502, a default setting page 504 can be presented. The default setting page 504 allows the user to configure default settings. Following the default setting page 504, a product information page 506 can be presented. The product information page 506 allows a user to enter product information pertaining to a new product. Following the product information page 506, a file upload page 508 can be presented. The file upload page 508 allows the user to specify digital files to be uploaded and associated with the new product. Following the file upload page 508, a distribution parameters page 510 can be presented. The distribution parameters page 510 allows the user to enter various parameters that affect distribution, such as pricing information. Following the distribution parameters page 510, a storefront and localization page 512 can be presented. The storefront and localization page 512 can allow the user to specify all or certain storefronts from which the new product is to be available for distribution (e.g., purchase). Also, to the extent that some of such storefronts are in geographically different regions of the world, the localization information can also be provided by the user. For example, the localization information can provided foreign language versions of some of the product information. Following the storefront and localization page 512, a product submission page 514 can be presented. The product submission page can allow the user to confirm data that has been provided for the new product and then cause the submission of such information to a product submission and management system, such as the product submission and management system 104 illustrated in FIG. 1.

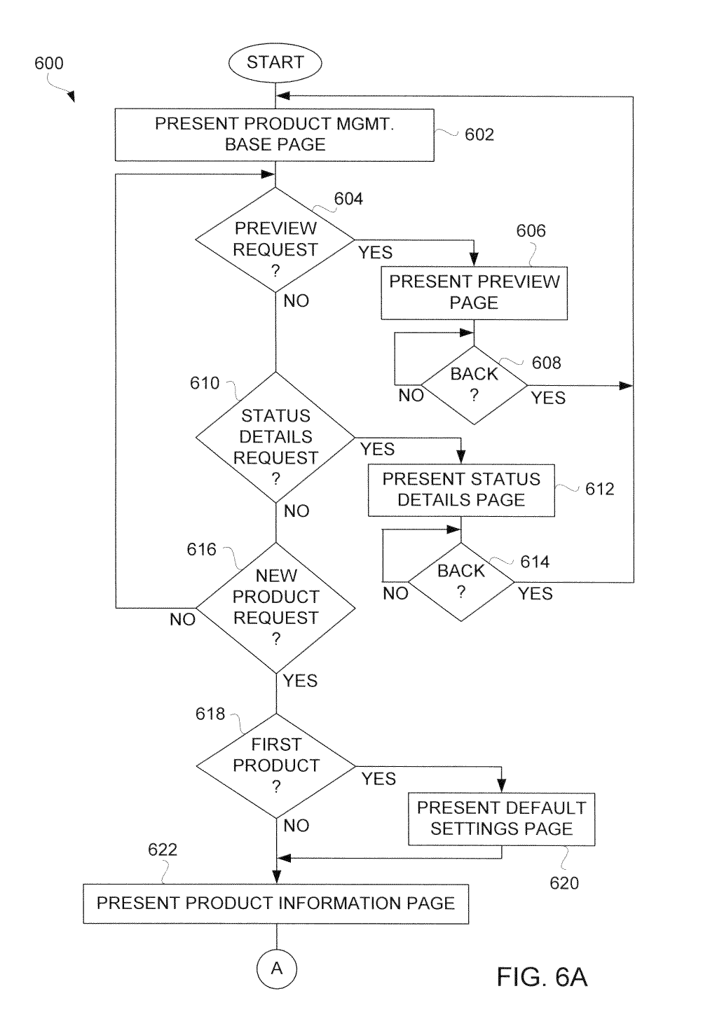

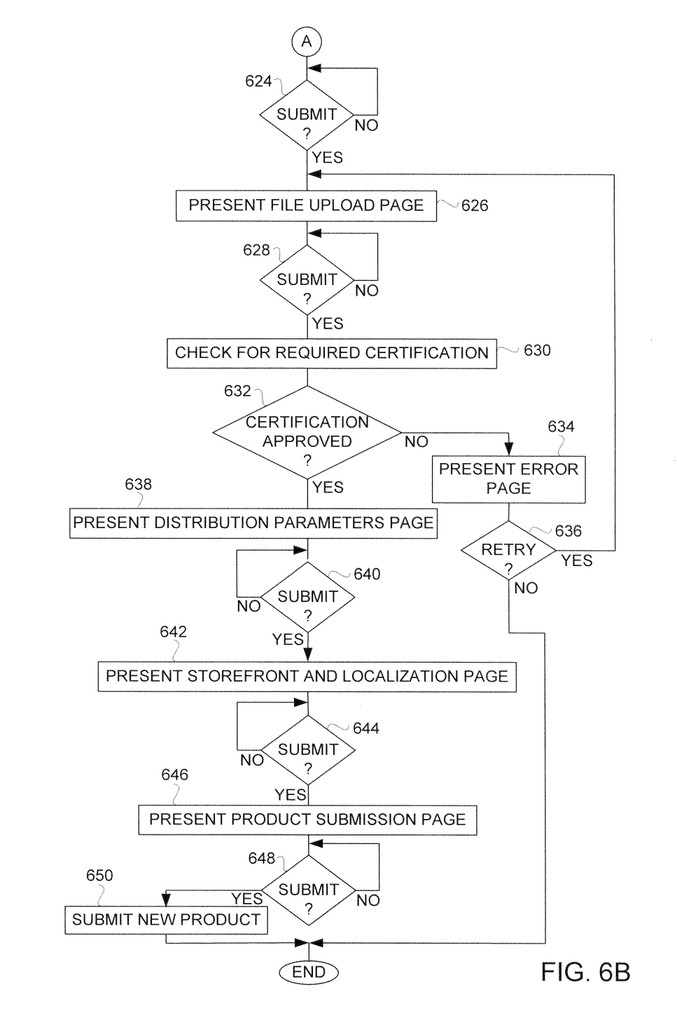

FIGS. 6A and 6B are flow diagrams of a product management process 600 according to one embodiment of the invention. The project management process 600 can be performed by a product management system, such as the product management system 500 illustrated in FIG. 5.

The product management process 600 can present 602 a product management base page. The product management base page, for example, can permit navigation to a new product page, a preview page and a status details page.

Next, a decision 604 can determine whether a preview request has been received. When the decision 604 determines that a preview request has been received, a preview page can be presented 606. A preview page can provide the user with a preview of how the digital product will be represented for distribution at the online distribution site. Following the presentation 606 of the preview page, a decision 608 can determine whether a back request has been received. When the decision 608 determines that a back request has not yet been received, the product management processing 600 can await such a request. However, once the decision 608 determines that a back request has been received, the product management process 600 can return to repeat the block 602 so that the product management base page can again be presented 602.

Alternatively, when the decision 604 determines that a preview request has not been received, a decision 610 can determine whether a status details request has been received. When the decision 610 determines that a status details request has been received, a status details page can be presented 612. In one implementation, a status details page can provide the user with details on submission status of a submission of a digital product. Following the presentation 612 of the status details page, a decision 614 can determine whether a back request has been received. When the decision 614 determines that a back request has not yet been received, the product management processing 600 can await such a request. However, once the decision 614 determines that a back request has been received, the product management process 600 can return to repeat the block 602 so that the product management base page can again be presented 602.

On the other hand, when the decision 610 determines that a status details request has not been received, a decision 616 can determine whether a new product request has been received. When the decision 616 determines that a new product request has not been received, the product management process 600 can return to repeat the decision 604 and subsequent blocks so that additional user requests can be processed. Alternatively, when the decision 616 determines that a new product request has been received, a decision 618 can determine whether the new product is a first product to be provided by the user to the product submission and management system. When the decision 618 determines that the new product is the first product, a default settings page can be presented 620. The user can interact with the default setting page to provide one or more default settings to be utilized by the product submission and management system.

Following the block 620, as well as directly following the decision 618 when the new product is not the first product, a product information page can be presented 622. The user can interact with the product information page to enter product information to be utilized by the product submission and management system. Thereafter, a decision 624 can determine whether the user has submitted the product information page. When the decision 624 determines that the user has not yet submitted the product information page, the product management process 600 can await its submission.

Once the decision 624 determines that the user has submitted the product information page, a file upload page can be presented 626. The user can interact with the file upload page to specify one or more digital files that are to be uploaded and associated with the new product. A decision 628 can then determine whether the user has submitted the file upload page. When the decision 628 determines that the user has not yet submitted the file upload page, the product management process 600 can await its submission. Once the decision 628 determines that the user has submitted the file upload page, at least one of the digital files being uploaded can be checked 634 for a required certification (or authentication). Here, in one embodiment, at least one of the one or more digital files being uploaded is required to be certified (or authenticated) by a trusted authority so that the product submission and management system can ensure that the files are appropriate for submission. Following the block 630, a decision 632 can determine whether the certification associated with the digital files has been approved. When the decision 632 indicates that certification is not approved, an error page can be presented 634. A decision 636 can determine whether the user is permitted to retry the uploading of digital files. When the decision 636 determines that a retry is permitted, the product management process 600 can return to repeat the decision 626 so that the user can again try to upload the one or more digital files.

On the other hand, when the decision 632 determines that the certification of the one or more digital files has been approved, a distribution parameters page can be presented 638. The distribution parameters page enables the user to enter one or more distribution parameters to be utilized during the distribution of the new product. For example, the user can specify pricing information to be utilized for the new product.

Following the presentation 638 of the distribution parameters page, a decision 640 determines whether the user has submitted the distribution parameters page. When the decision 640 determines that the user has not yet submitted the distribution parameters page, the product management process 600 can await its submission. Alternatively, when the decision 640 determines that the user has submitted the distribution parameters page, a storefront and localization page can be presented 642. The storefront and localization page enables the user to specify one or more particular storefronts from which the new product is to be made available for distribution. Additionally, the localization information can be provided when appropriate for such storefronts, such as when they are in different language countries. Following the presentation 642 of the storefront and localization page, a decision 642 can determine whether the user has submitted the storefront and localization page. When the decision 644 determines that the user has not yet submitted the storefront and localization page, the product management process 600 can await its submission. In another embodiment, localization can be provided in a localization page while storefront information can be provided in a storefront page. Thus, localization and storefront information can be provided can be provided with separate pages, a combined page, or a combination of other pages. For example, the storefront information can be provided with a distribution parameters page.

Alternatively, when the decision 644 determines that the user has submitted the storefront and localization page, a product submission page can be presented 646. The product submission page can facilitate the user in reviewing the previously provided information pertaining to the new product. In other words, the product submission page can allow the user to confirm the information about the new product that is about to be submitted to the product submission and management system. A decision 648 can then determine whether the user has submitted the product submission page. When the decision 648 determines that the user has not yet submitted the product submission page, the product management process 600 can await its submission. Alternatively, once the decision 648 determines that the user has submitted the product submission page, the product management process 600 submits 650 the information concerning the new product to the product submission and management system. After the submission 650, the product management process 600 can end.

Alternatively, following the block 636 when a retry is not permitted, the product management process 600 can also end but in this case without having submitted a new product to the product submission and management system.

After a digital product has been submitted to a product submission and management system, a quality review process can be initiated. The quality review can have a number of states, including: in review, ready for sale, rejected or pending contract. The “in review” state is the initial state until the submission is rejected or approved. The “ready for sale” state is the status once the application file has been approved. The “rejected” state is the status if quality review finds the application filed deficient or defective. The “pending contract” state is the state when submitter lacks a contractual agreement for distribution.

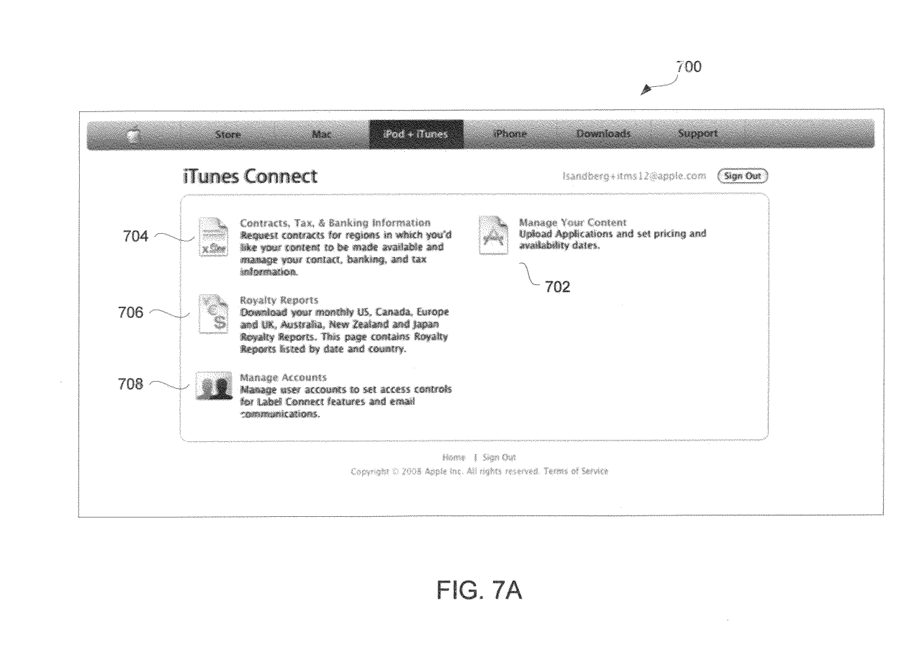

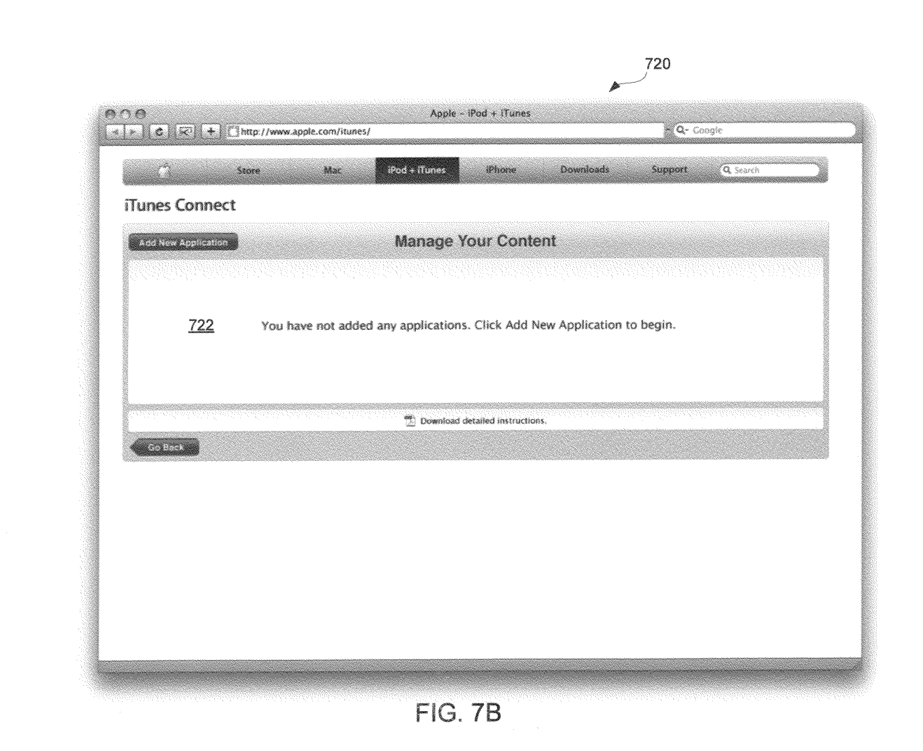

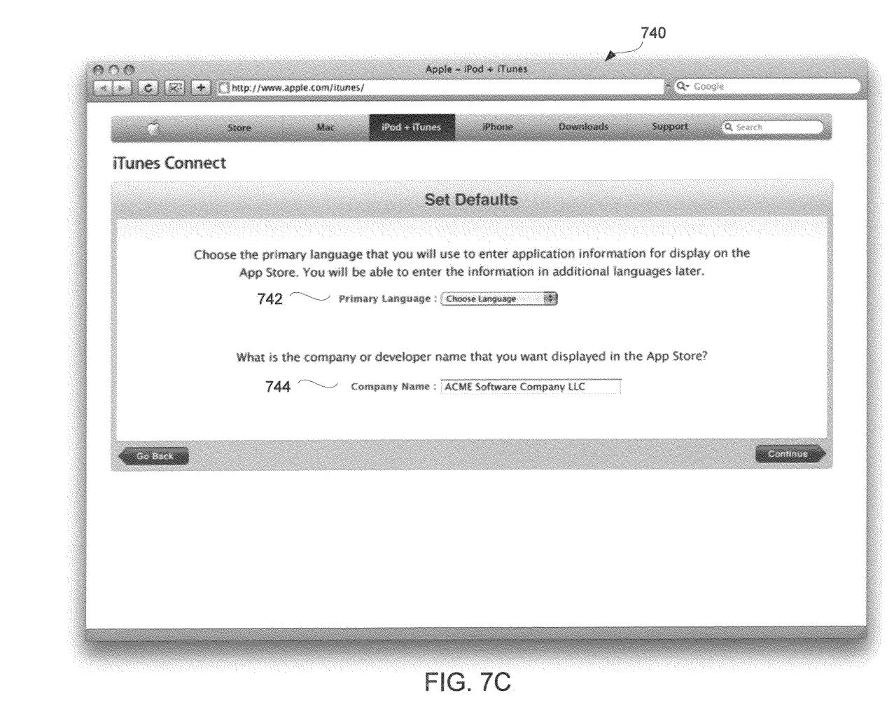

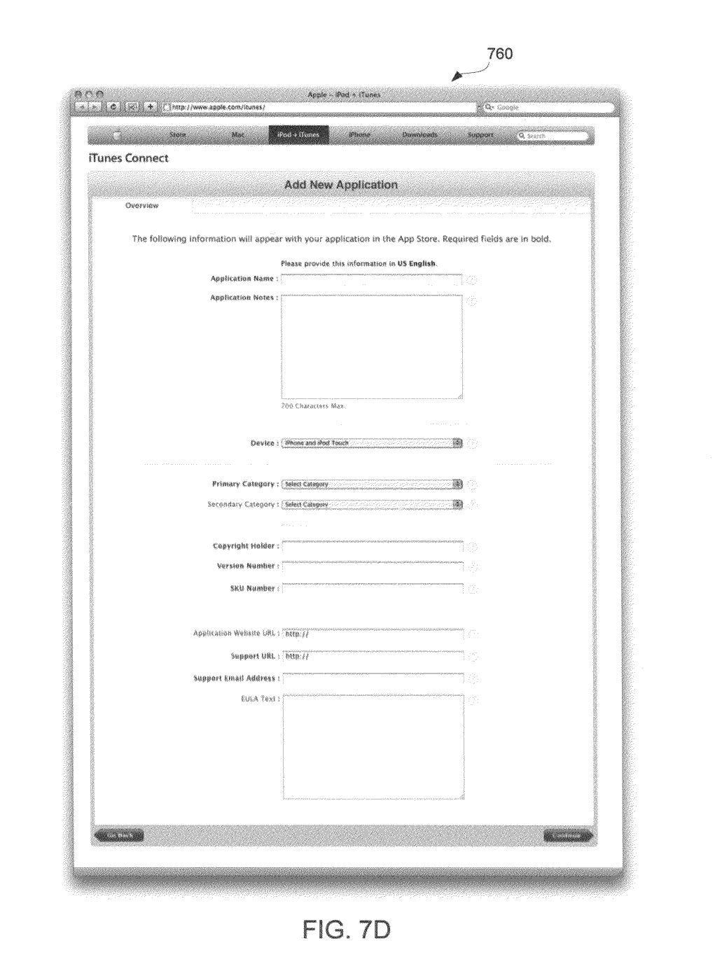

Another aspect of the invention pertains to graphical user interfaces. The graphical user interfaces can present various pages (or screens), including those discussed above, to assist a user in interacting with a product submission and management system (or an online product distribution site). FIGS. 7A-12B are screen shots pertaining to representative graphical user interfaces.

FIGS. 7A-7D are representative screen shots pertaining to basic user interaction with an online product distribution site according to one embodiment of the invention.

FIG. 7A is a representative screen shot of a system navigation page 700 according to one embodiment of the invention. The system navigation page 700 can provide user access to a plurality of functional modules, for example, a product management module 702 (“Manage Your Content”), a contract request module 704 (“Contracts, Tax & Banking Information”), a royalty module 706 (“Royalty Reports”), or an account management module 708 (“Manage Accounts”). These functional modules are similar to the modules 306-312 illustrated in FIG. 3. The system navigation page 700 can, for example, represent the system navigation page 304 illustrated in FIG. 3.

FIG. 7B is a representative screen shot of a product management base page 720 according to one embodiment of the invention. The product management base page 720 can, for example, represent the product management base page 502 illustrated in FIG. 5 or the product management base page presented 602 in FIG. 6A. The product management based page 720 can be utilized by a user to manage submission of digital products to a product submission and management system for eventual distribution by an online product distribution site. The product management base page 720 includes a new application window 722. The new application window 722 can list or otherwise identify any applications that have been submitted to the product submission and management system for eventual distribution by the online product distribution site. As illustrated in FIG. 7B, the new application window is empty because the user has not yet added any applications for submission to the online product distribution site.

FIG. 7C is a representative screen shot of a default settings page 740 according to one embodiment of the invention. The default settings page 740 can, for example, represent the default settings page 504 illustrated in FIG. 5 or the default settings page presented 620 in FIG. 6A. The default settings page 740 is utilized by a user to set initial settings to be utilized with the product submission and management system for eventual distribution by the online product distribution site. In the example illustrated in FIG. 7C, the initial settings pertain to a primary language and any company name. More particularly, the default settings page 740 can display a primary language selector 742 for user selection of a primary language for digital products to be distributed via the online product distribution site. The default settings page 740 can also display a company name area 744 where the user can provide the name of the company that is offering the digital products for sale via the online product distribution site.

FIG. 7D is a representative screen shot of a product information page 760 according to one embodiment of the invention. The product information page 760 can, for example, represent the product information page 506 Illustrated in FIG. 5 or the product information page presented 622 in FIG. 6A. The product information page 760 can be utilized by a user to provide product information for a new product (e.g., new application) being submitted by the user to the product submission and management system for eventual distribution by the online product distribution site. As illustrated in FIG. 7D, the product information page 760 can present a webpage form to the user such that the user can provide particular product information for the new digital product being submitted. Specifically, the webpage form illustrated in FIG. 7D requests product information, including: application name, application notes, device (suitable devices), primary category (genre) for the digital product, secondary category (genre) for the digital product, copyright holder, version number, SKU number, application website URL, support URL, support e-mail address, and license agreement text (EULA text). The suitable devices can thus be identified by the user. For example, when the new digital product is a new application executable only on certain hardware or software applications, the user can so designate the suitable devices or device types. Additionally, the entry of the product information can be validated for appropriate data entry into the webpage form before being accepted.

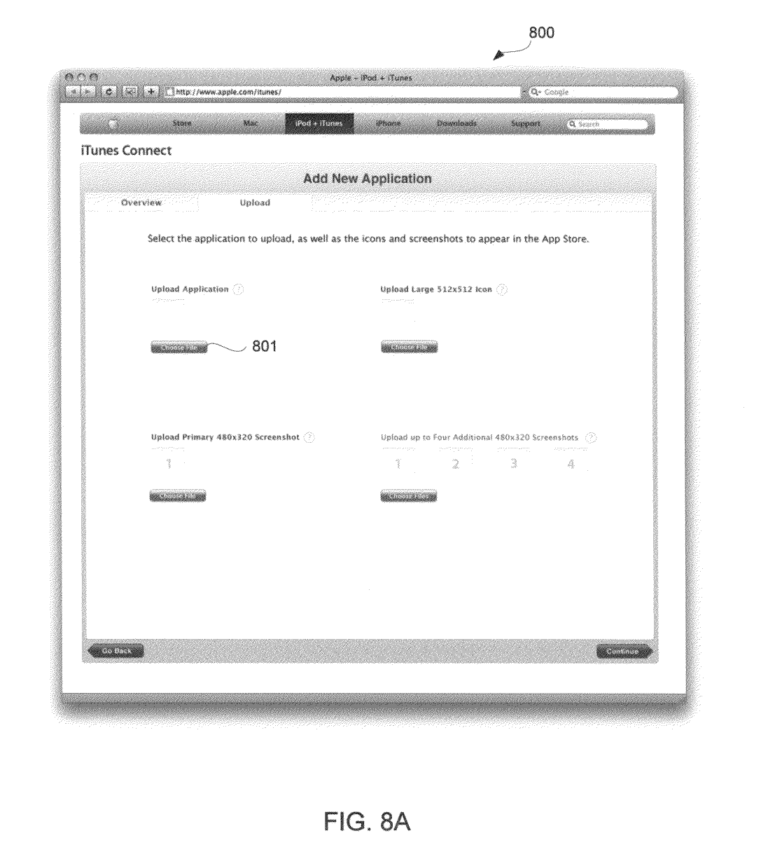

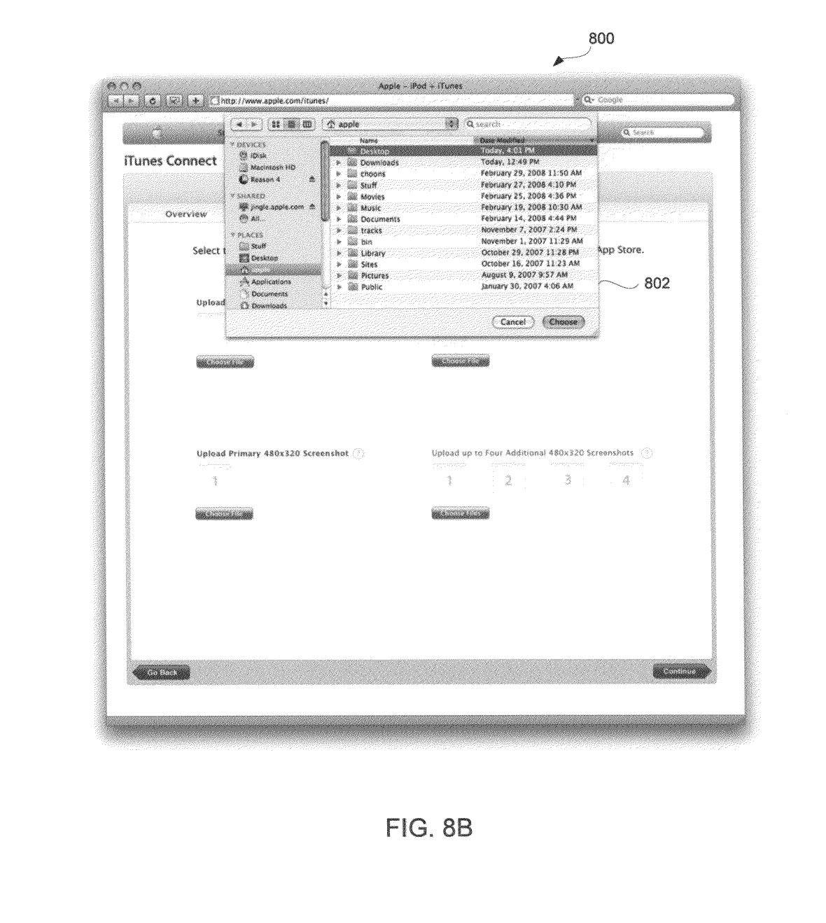

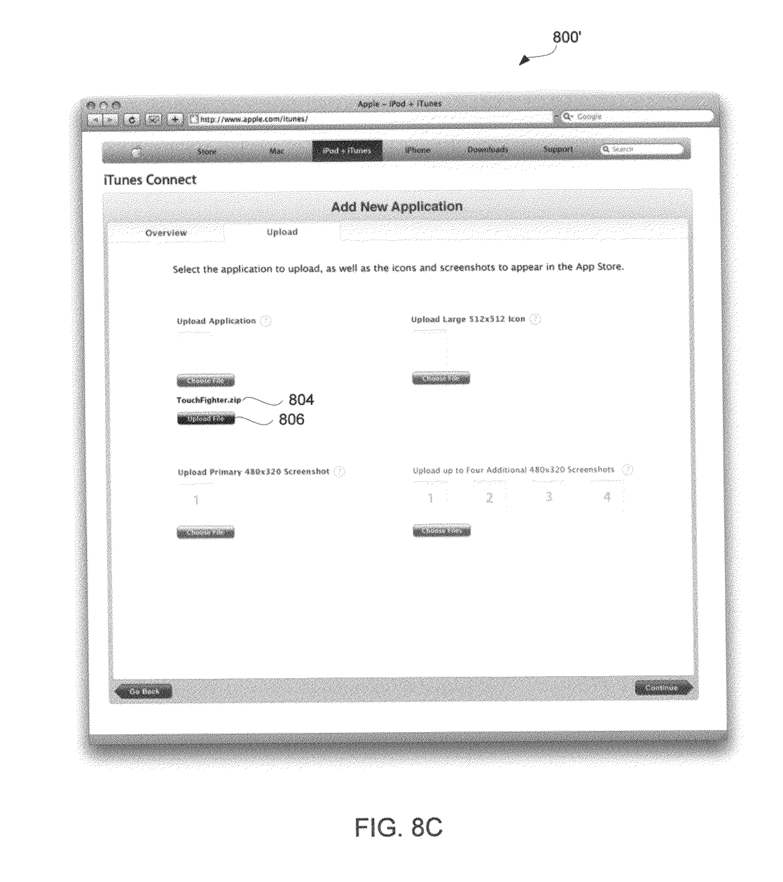

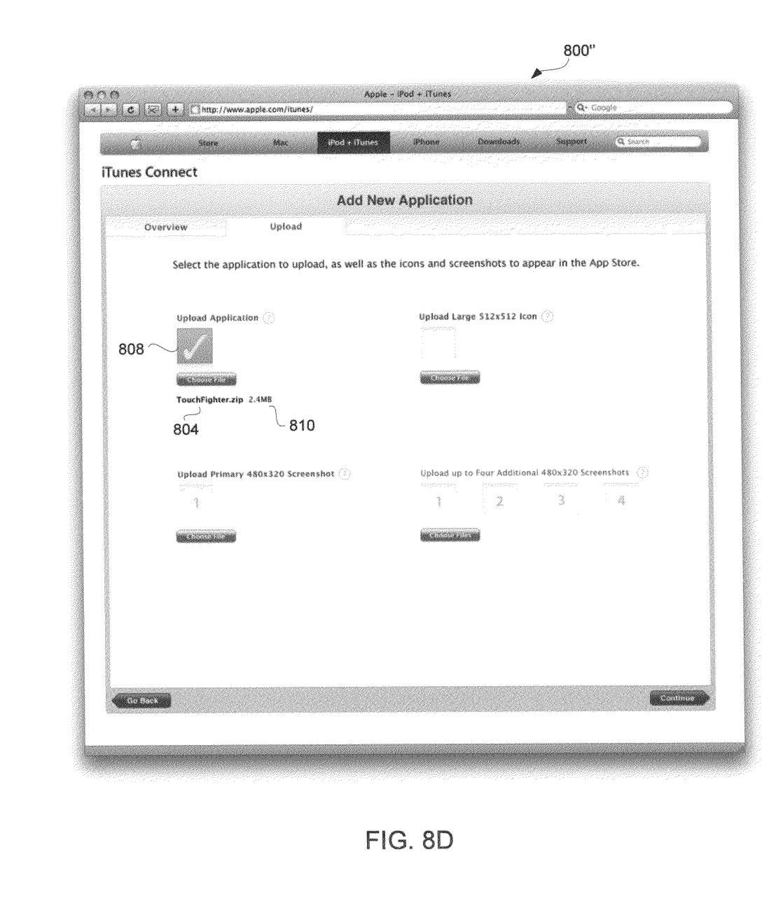

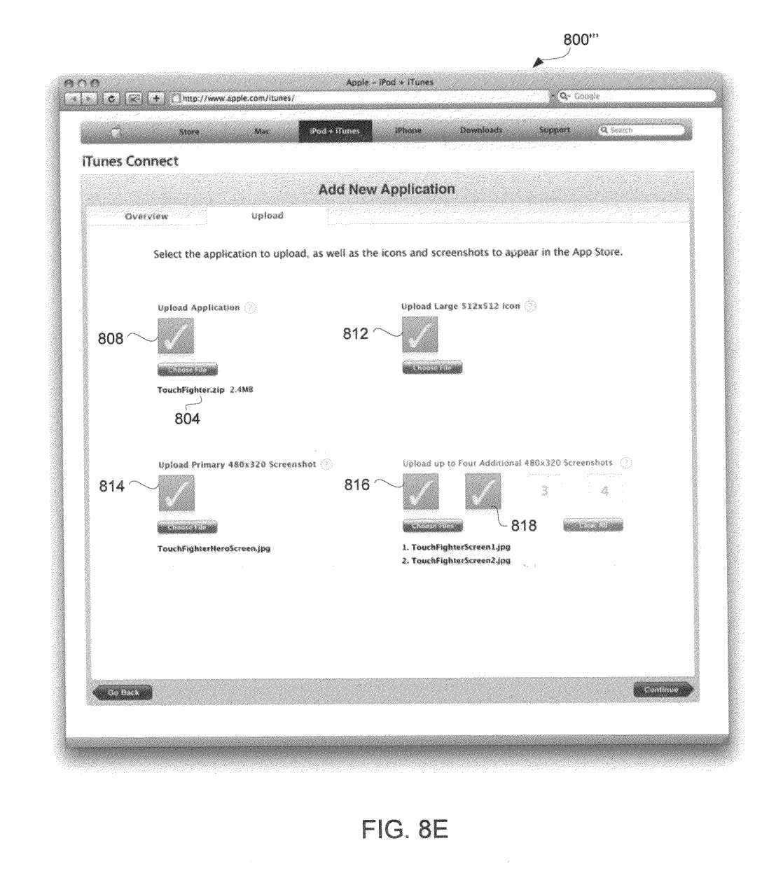

FIGS. 8A-8E are representative screen shots pertaining to uploading of one or more files according to one embodiment of the invention. The one or more files being uploaded to pertaining to a digital product being submitted to the product submission and management system for eventual distribution by the online product distribution site.

FIG. 8A illustrates a file upload page 800 according to one embodiment of the invention. The file upload page 800 allows a user to select one or more digital files to be associated with a digital product being submitted. The one or more digital files can include an application file as well as files pertaining to one or more icons and/or screen shots. The icons and/or screen shots can be utilized by the online product distribution site when the digital product being submitted is offered for distribution (purchase or rental). For example, when the digital product pertains to a computer software application, the file upload page 800 permits a user to select the application file (e.g., executable program file) to upload as well as to specify one or more icons and/or screen shots associated with the computer software application.

As illustrated in FIG. 8B, to identify an application file to be uploaded, the user can select a choose file control 801. In response to selecting the choose file control 801, a file identification dialog box 802 can be presented over the file upload page 800 as shown in FIG. 8B. The user can utilize the file identification dialog box 802 to specify the application file to be uploaded. Once the user utilizes the file identification dialog box 802 to choose a particular application file to be uploaded, the file upload page 800 can be updated. FIG. 8C illustrates an updated file upload page 800′. As shown in FIG. 8C, the file upload page 800′ is now updated to specify an identifier 804 for the chosen file. In addition, the file upload page 800′ can present an upload file control 806. Upon selection of the upload file control 806, the upload operation of the chosen file specified by the identifier 804 can be initiated. In one implementation, the application file can be required to a compressed file format (e.g., “.zip”) including a binary file for the application and an icon for display on a device that executes the program. Also, in one implementation, the upload of the application file can require a successful code sign check (i.e., digital signature verification for authentication). Once the file has successfully uploaded, the file upload page 800′ can again be updated as illustrated in FIG. 8D. In FIG. 8D, the file upload page 800″ can include an upload completion indicator 808. The upload completion indicator 808 indicates that chosen file associated with the identifier 804 has been uploaded. A file size indicator 810 can also be presented on the file upload page 800″ to indicate the size of the chosen file which has been uploaded. Still further, the user can further interact with the file upload page 800″ such that one or more icons and/or screen shots associated with the digital product (e.g., computer software application) can similarly be uploaded.

FIG. 8E illustrates the file upload page 800′″ after chosen files for each of the application, an icon, a primary screen shot, and a pair of additional screen shots have been uploaded. These uploaded files for the digital product are eventually used by the online product distribution site when distributing the digital product. As illustrated in FIG. 8E, all of these mentioned files have been uploaded and the upload file page 800′″ displays indicators 808, 812, 814, 816 and 818 to inform the user that these files have been successfully uploaded. The indicator 812 indicates that a specified icon file has been uploaded. The indicator 814 indicates that a specified primary screen shot has been uploaded. The indicators 816 and 818 specify that a two additional screen shots have been uploaded.

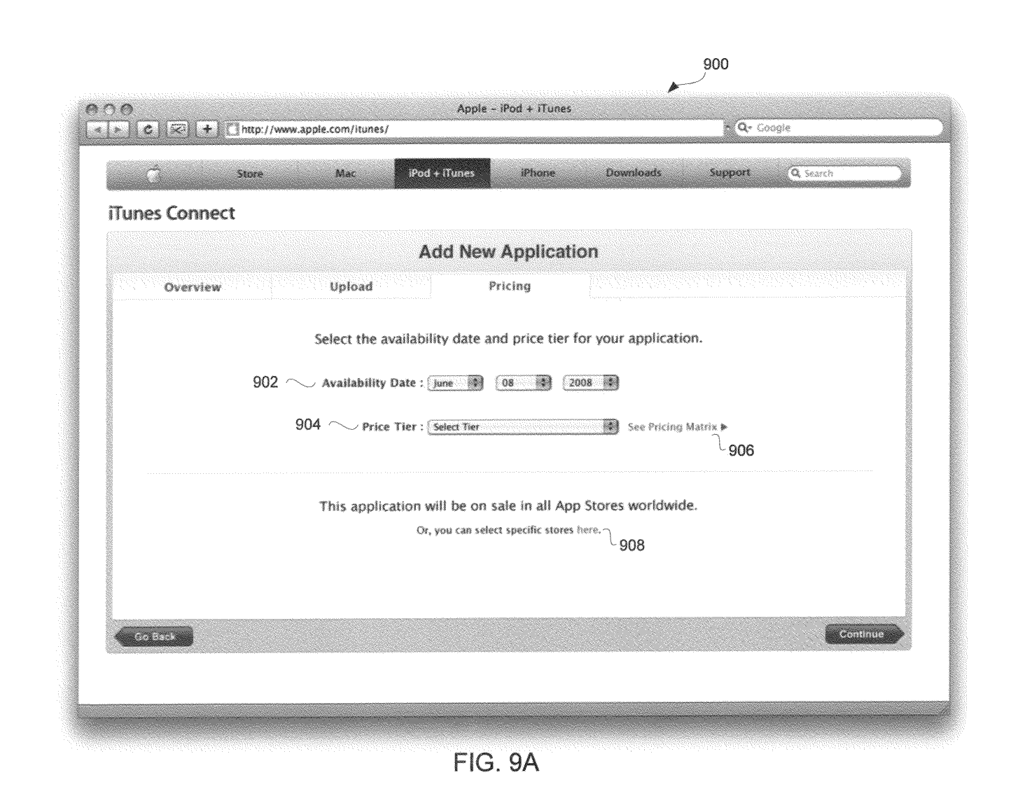

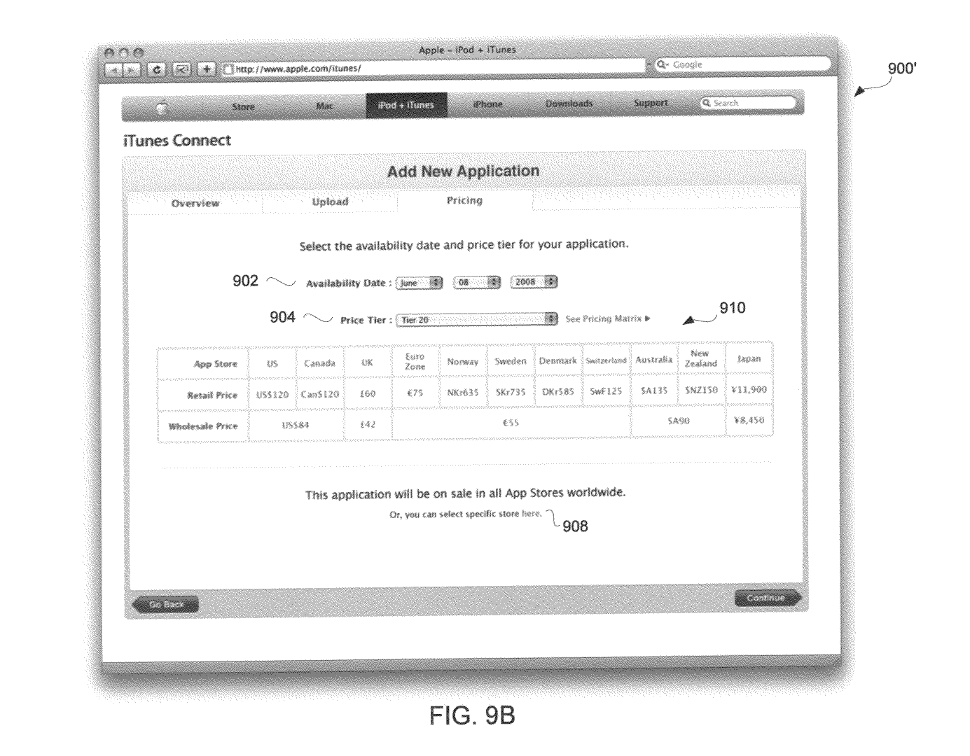

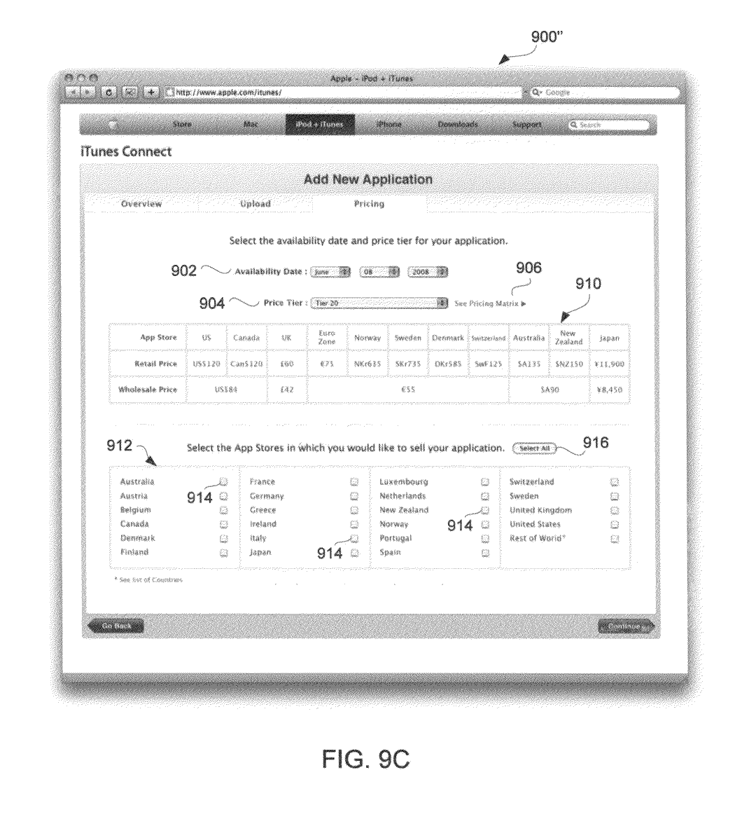

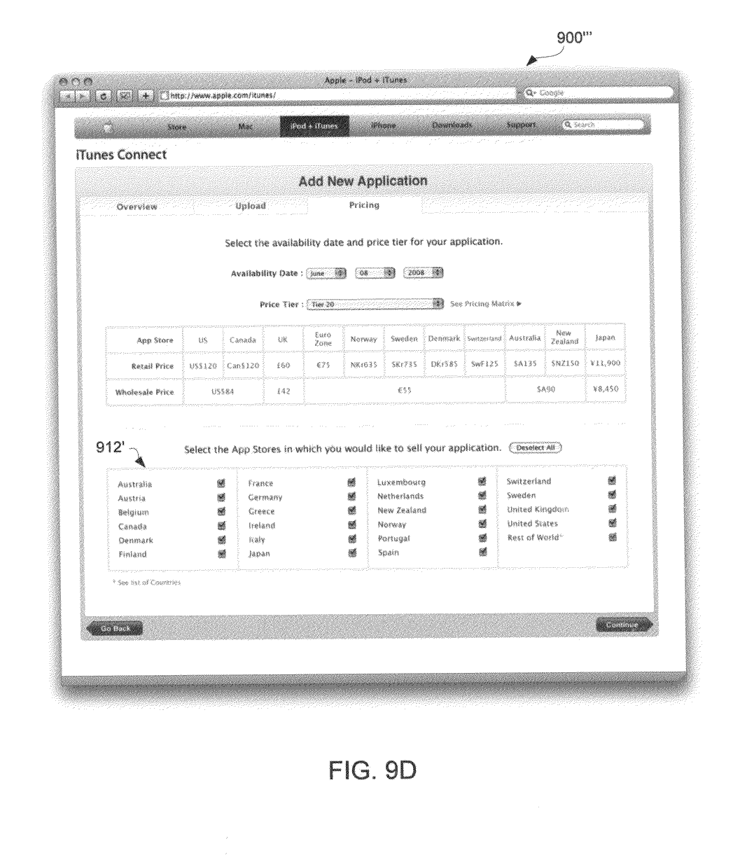

FIGS. 9A-9D are representative screen shots pertaining to setting pricing parameters according to one embodiment of the invention. The pricing parameters are associated with and used for a digital product being submitted to the product submission and management system for eventual distribution by the online product distribution site.

FIG. 9A is a representative screen shot of a pricing parameters page 900 according to one embodiment of the invention. The pricing parameters page 900 represents one implementation of a distribution parameters page, such as the distribution parameters page 510 illustrated in FIG. 5 or the distribution parameters page presented 638 as illustrated in FIG. 6B. The pricing parameters page 900 includes an availability date selector 902 and a pricing tier selector 904. The user can interact with the availability date selector 902 to select an availability date to be associated with the digital product being submitted to the product submission and management system. The availability date is the date that the online product distribution site is authorized to distribute the digital product. In addition, the user can interact with the price tier selector 904 to select a pricing tier to be associated with the digital product. The pricing tier is the pricing structure that is utilized by the online product distribution site when distributing the particular digital product. The pricing parameters page 900 also includes an availability control 908.

When the user considering the appropriate pricing tier to select using the price tier selector 904, the user can review additional details on pricing structures by selecting a pricing matrix control 906. Selection of the pricing matrix control 906 causes a pricing matrix to be displayed. FIG. 9B illustrates the pricing parameters page 900′ following the user selection of the pricing matrix control 906. The pricing parameters page 900′ is the same as the pricing parameters page 900 except that a pricing matrix 910 is now displayed. The pricing matrix 910, in the embodiment illustrated in FIG. 9B, provides a pricing structure based on the relationship between the online store selling the digital product (e.g. different countries) along with retail and wholesale prices.

When the user selects the availability control 908, the pricing parameters page 900′ can be updated to a pricing parameters page 900″ as illustrated in FIG. 9C. In particular, the pricing parameters page 900″ further includes a store-specific availability control table 912. Using the store-specific availability control table 912, the user can designate individual stores using selectors 914 or can use a “select all” control 916 to select all of the stores. In the event that all of the stores are individually selected or selected using the “select all” control 916, the pricing parameters page 900″ can be updated to a pricing parameters page 900′″ as illustrated in FIG. 9D. In FIG. 9D, the store-specific availability control table 912′ is updated to show the store-specific availability control table 912 with each of the individual store selectors 914 being checked.

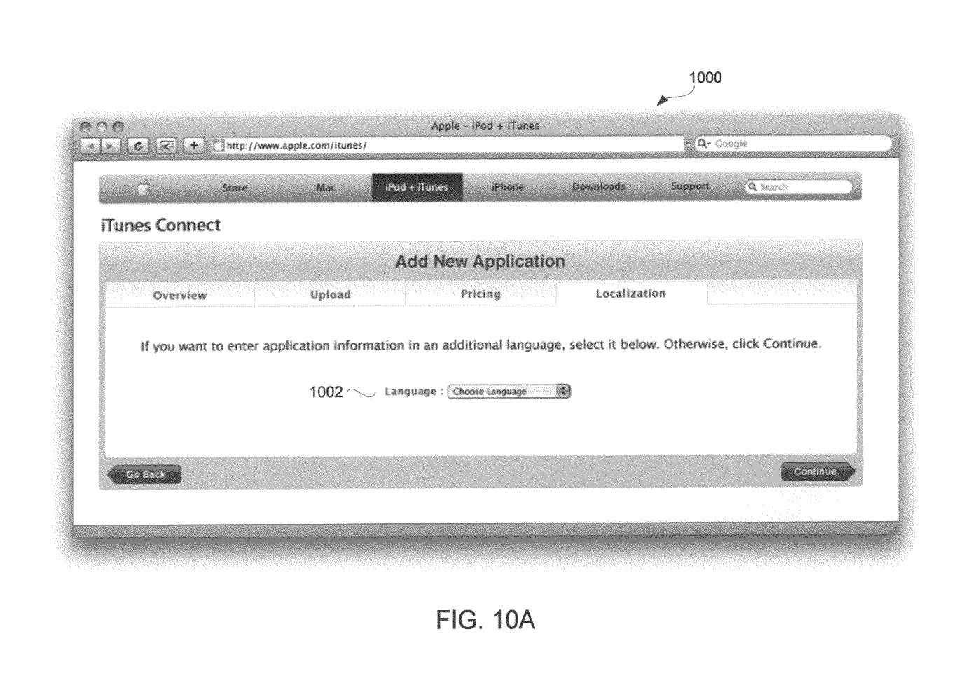

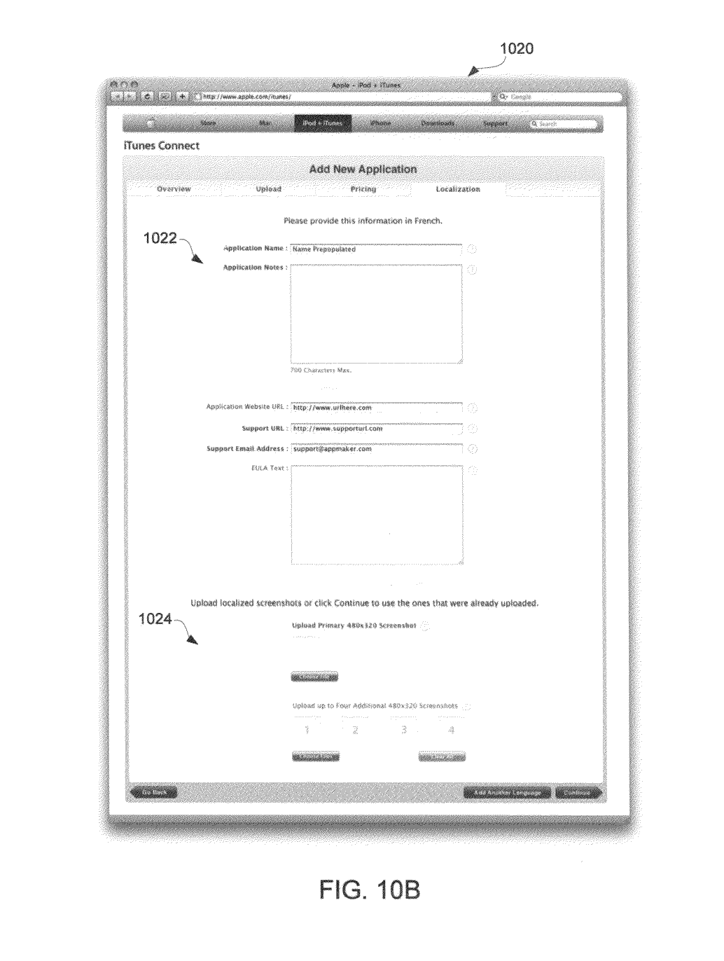

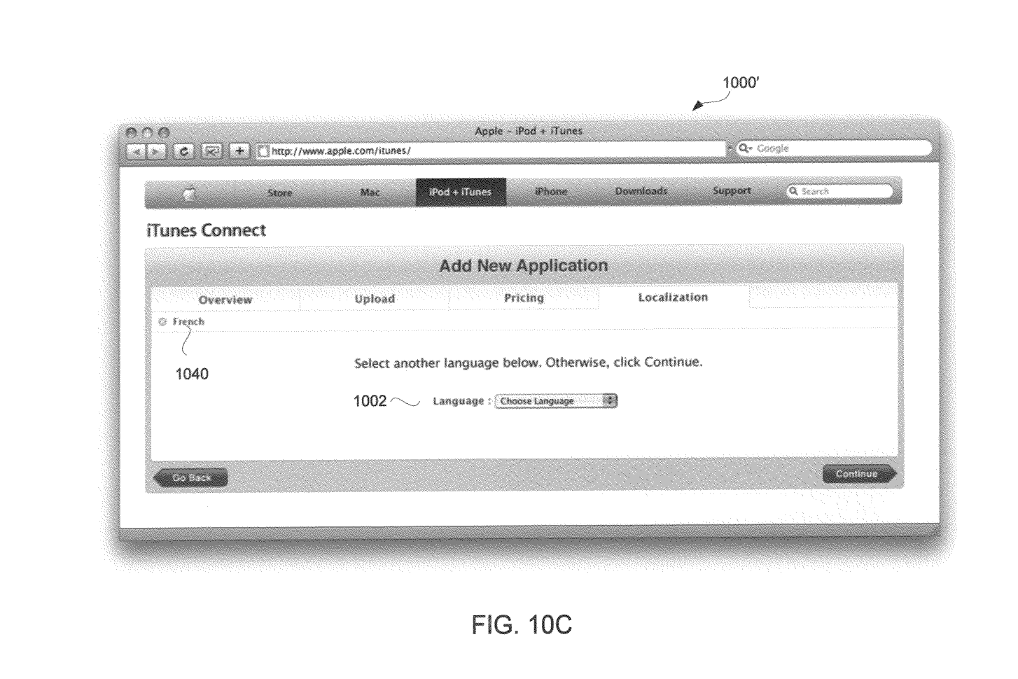

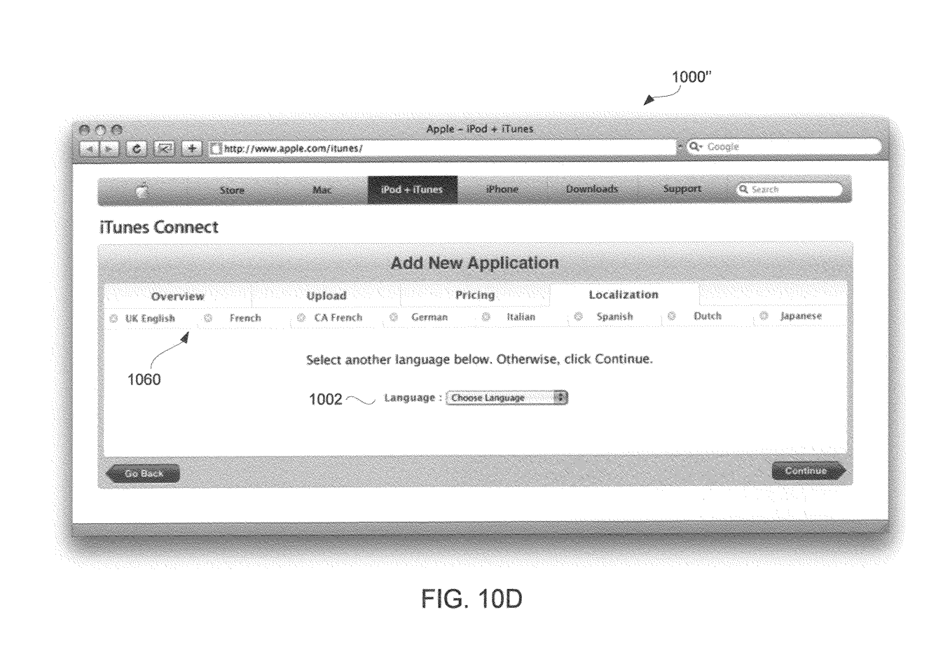

FIGS. 10A-10D are representative screen shots pertaining to setting localization parameters according to one embodiment of the invention. The localization parameters are associated with and used for a digital product being submitted to the product submission and management system for eventual distribution by the online product distribution site. For example, when the online product distribution site offers products for sale through use of different online stores associated with different countries or regions, it can be advantageous to provide localized product information.

FIG. 10A is a screen shot of a localization page 1000 according to one embodiment of the invention. The localization page 1000 can, for example, represent one embodiment of the storefront and localization page 512 illustrated in FIG. 5 or the storefront and localization page being presented 642 as illustrated in FIG. 6B. The localization page 1000 includes a language selector 1002. Using the language selector 1002, the user can provide one or more additional languages for the digital product being submitted so that some localized product information can be configured. For example, if the user utilizes the language selector 1002 to select “French” as an additional language to be supported, a product information localization page can be presented.

FIG. 10B illustrates a representative product information localization page 1020 according to one embodiment of the invention. The product information localization page 1020 includes a product information region 1022 that permits the user to enter localized product information for those online stores utilizing “French” as the appropriate language. As illustrated in FIG. 10B, certain of the product information fields that are editable by the user can be pre-populated with information party entered using the product information page for the primary language (see FIG. 7D). As a result, the user can utilize a different application name, different application notes, different URLs, different e-mail addresses, and different license agreements in different countries or geographic areas. The product information localization page 1020 can also include a screen shot localization region 1024. Using the screen shot localization region 1024, the user can provide different screen shots to be utilized when offering the digital product for sale at the different online stores in the different countries or geographic regions.

After new user is done interacting with and the product information localization page 1020, FIG. 10C can present a localization page 1000′. The localization page 1000′ illustrated in FIG. 1C represents an updated version of the localization page 1000 illustrated in FIG. 1A. As shown in FIG. 10C, a French indication 1040 signals that the digital product has certain localization information for an online store utilizing French as its language. At this point, the user can continue to select additional languages using the language selector 1002 and again provide localization information. In the event that the user does continue to enter localization information for other different languages, as an example, the localization page 1000′ can further update as shown in FIG. 10D. FIG. 10D illustrates a screen shot of a representative localization page 1000″. The localization page 1000″ includes a localization reference area 1060 that provides indications of the one or more different countries or geographic regions for which localization information has been provided for the digital product.

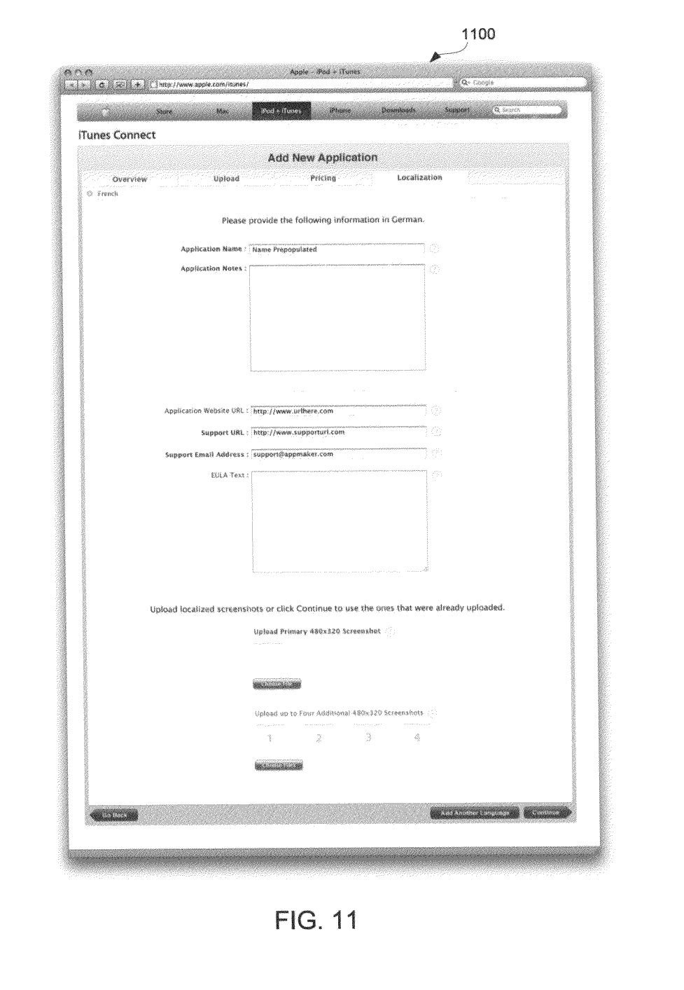

FIG. 11 is a screen shot of a representative product submission page 1100 according to one embodiment of the invention. The product submission page 1100 can present to the user a summary of the product, uploaded files, pricing, localization and other information that the user has provided or designated for a particular digital product. The product submission page 1100 allows the user to confirm such information and, once confirmed, cause the formal submission of the digital product and all its provided information to the online product distribution site.

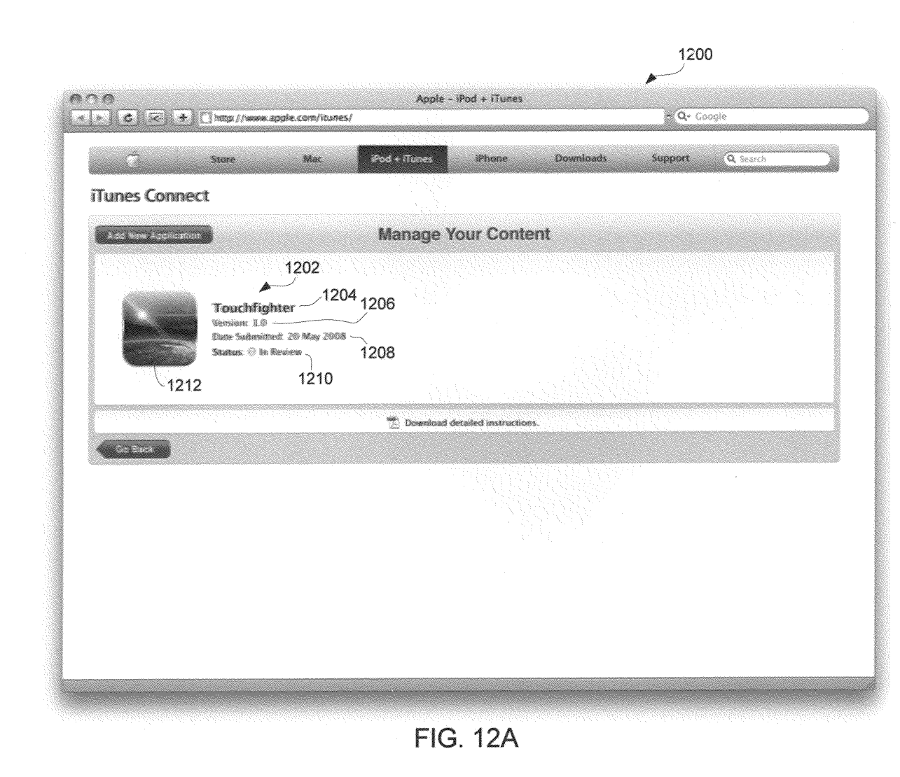

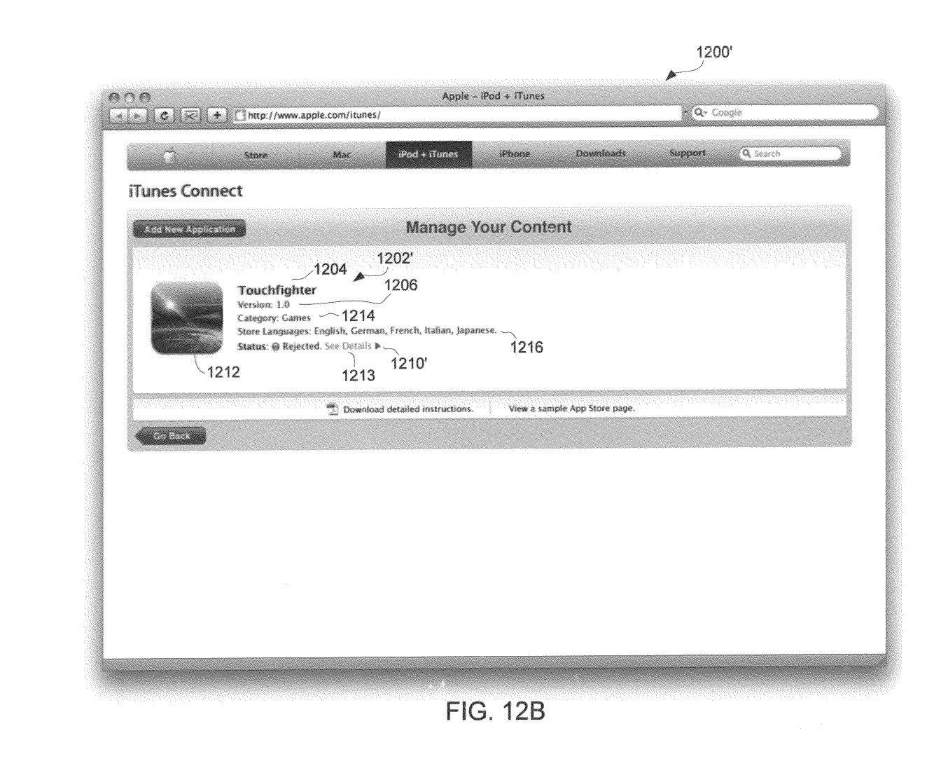

FIG. 12A is a screen shot of a representative product management base page 1200 according to one embodiment of the invention. The product management base page 1200 provides a product designation region 1202. The product designation region 1202 can include a product name 1204, a version indication 1206, a submission date 1208, a status indication 1210, and an image representation 1212. The product name 1204, the version indication 1206 and the image representation 1212 are items that were previously provided during the submission process. The date submitted 1208 is the date that the user made the formal submission of the digital product to the product submission and management system for eventual distribution by the online product distribution site. The status indication 1210 can indicate, as illustrated in FIG. 12A, that the digital product that has been submitted is currently under review. Since the digital product is under review (and thus not yet approved), the digital product is not yet offered for sale by the online product distribution site.

FIG. 12B is a screen shot of a representative product management base page 1200′ according to one embodiment of the invention. The product management base page 1200′ represents another instance of the product management base page 1200 at another point in time. In particular, the product management base page 1200′ can represent a point in time after review of the digital product has been preformed. As illustrated in FIG. 12B, the product designation region 1202 indicates the product name 1204, the product version 1206, the status indication 1210, and the image representation 1212. Here, the status indication 1210′ now indicates that the associated digital product has been rejected by the online product distribution site. In one embodiment, a link 1213 can be provided to the user on the product management base page 1200′ so that the user can retrieve additional information or assistance with understanding why the submitted digital product was rejected and how the rejection might be overcome. Still further, the product designation region 1202′ can also include category information 1214 and supported languages 1216. The category information 1214 results from the genre selections made during the providing of product information, and the supported languages 1216 are those languages that were provided when providing localization information.

This application also references and/or incorporates: (1) U.S. patent application Ser. No. 10/687,534, filed Oct. 15, 2003, and entitled “METHOD AND SYSTEM FOR SUBMITTING MEDIA FOR NETWORK-BASED PURCHASE AND DISTRIBUTION” [Att.Dkt.No. 101-P291], which is hereby incorporated herein by reference; (2) U.S. patent application Ser. No. 11/609,815, filed Dec. 12, 2006, and entitled “TECHNIQUES AND SYSTEMS FOR ELECTRONIC SUBMISSION OF MEDIA FOR NETWORK-BASED DISTRIBUTION” [Att.Dkt.No. 101-P508], which is hereby incorporated herein by reference; and (3) U.S. patent application Ser. No. 11/622,923, filed Jan. 12, 2007, and entitled “COMPUTERIZED MANAGEMENT OF MEDIA DISTRIBUTION AGREEMENTS” [Att.Dkt.No. 101-P511], which is hereby incorporated herein by reference.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that submission of digital products, such as computer programs (applications), to online distribution sites can be achieved by numerous persons (e.g., developers) with uniformity. The uniformity facilitates processing, approving and distributing the computer programs by representatives of the online distribution sites to process the digital product. Another advantage of certain embodiments of the invention is that digital product submissions can be user-controlled through information/authorizations provided with submission of digital products to online distribution sites. Still another advantage of certain embodiments of the invention is that users can gain online access to status information of digital product submission.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for submitting a digital product to an online repository for distribution, said method comprising:
receiving product information pertaining to a digital product to be submitted to the online repository;
uploading at least one electronic file pertaining to the digital product;
receiving at least one distribution parameter to be used for the digital product; and
submitting the digital product to the online repository for distribution.

2. A method as recited in claim 1, wherein the digital product is a computer program product.

3. A method as recited in claim 1, wherein said submitting comprises submitting the product information, the at least one distribution parameter and the at least one electronic file to the online repository.

4. A method as recited in claim 1, wherein said method further comprises:
authenticating the at least one electronic file prior to said submitting of the digital product to the online repository.

5. A method as recited in claim 4, wherein the digital product is a computer program product.

6. A method as recited in claim 4, wherein said submitting is prevented if said authenticating does not authenticate the at least one electronic file pertaining to the digital product.

7. A method as recited in claim 1, wherein the at least one distribution parameter is a pricing parameter.

8. A method as recited in claim 7, wherein the pricing parameter is a price tier.

9. A method as recited in claim 1, wherein said method further comprises:
receiving storefront availability data to be associated with the digital product.

10. A method as recited in claim 1, wherein said method further comprises:
receiving alternative language product information.

11. A method as recited in claim 1, wherein the product information includes at least a product name and a supported device type indication.

12. A method as recited in claim 11, wherein the product information further includes at least a version number and a product identifier.

13. A method as recited in claim 12, wherein the digital product is a computer program product.

14. A method as recited in claim 1, wherein the product information includes at least a product name, a supported device type indication, genre indication, version number, product identifier, support information, and license agreement information.

15. A method as recited in claim 14, wherein the digital product is a computer program product.

16. A system for facilitating submission and management of digital products to be distributed online, said system comprising:
a product management and distribution system configured to permit content providers to submit digital products and manage distribution of their digital products, said product management and distribution system including at least:
a product submission module configured to receive submission of new digital products for distribution, each of the new digital products being submitted including at least providing product information and product distribution information,
wherein the product information includes at least a product name and a supported device type indication, and wherein the product distribution information includes at least one pricing parameter for use in online distribution of the corresponding digital product.

17. A system as recited in claim 16, wherein the digital product is a computer program product.

18. A system as recited in claim 16, wherein the product information further includes at least a genre indication, version number, product identifier, support information, and license agreement information.

19. A system as recited in claim 16, wherein said product management and distribution system further comprises:
a preview module configured to provide a preview presentation for the corresponding new digital product, the distribution presentation resembling a presentation subsequently to be used when distributing the corresponding new digital product online.

20. A system as recited in claim 16, wherein said product submission module is further configured to authenticate at least one electronic file pertaining to the digital product prior to submission.

21. A system as recited in claim 16, wherein the pricing parameter is a price tier.

22. A system as recited in claim 16, wherein the product distribution information further includes storefront availability data to be associated with the digital product.

23. A system as recited in claim 22, wherein the storefront availability data is used to control from which of a plurality of different online storefronts the corresponding digital product is authorized to be distributed online.

24. A system as recited in claim 23, wherein the product distribution information further includes localization information to be associated with the digital product, and wherein the localization information is used to cause presentation of the corresponding digital product at the different online storefronts to differ.

25. A graphical user interface for use in submitting a digital product to an online distribution site, said graphical user interface comprising:
a digital product information window for assisting a user in providing product information, the product information including information that is associated with a digital product;
an digital product upload window for assisting the user in selecting and uploading one or more electronic files that pertain to the digital product; and
a distribution parameters window for assisting the user in specifying one or more distribution parameters that are used to control one or more aspects of distribution of the digital product by the online distribution site.

26. A graphical user interface as recited in claim 25, wherein the product information includes at least a product name and a supported device type indication

27. A graphical user interface as recited in claim 26, wherein the product information further includes at least a genre indication, version number, product identifier, support information, and license agreement information.

28. A graphical user interface as recited in claim 25, wherein the one or more distribution parameters includes at least one pricing parameter for use in online distribution of the digital product.

29. A graphical user interface as recited in claim 25, wherein the at least one pricing parameter is a price tier.

30. A graphical user interface as recited in claim 25, wherein the digital product is a computer program product.

31. A graphical user interface as recited in claim 30, wherein the one or more electronic files being uploaded for the computer program product include an application file, an icon and at least one screen shot.

32. A graphical user interface as recited in claim 25, wherein at least one of the distribution parameters pertains to a price tier or an availability date.

33. A graphical user interface as recited in claim 25, wherein said graphical user interface further comprises:
a localization window for assisting the user in localizing the product information for distribution at different geographical areas.

34. A graphical user interface as recited in claim 25, wherein said graphical user interface further comprises:
a product management window for presenting a product designating region, the product designating region including at least a product designation and a submission status indication for at least one submitted product.
